(19) United States
(12) Patent Application Publication
(10) Pub. No.: US 2016/0026736 A1
(43) Pub. Date: Jan. 28, 2016

(54) METHOD AND APPARATUS FOR IDENTIFYING AND RECOMMENDING EXCHANGING OF DIGITAL ASSETS

(71) Applicant: Verizon Patent and Licensing Inc., Arlington, VA (US)

(72) Inventors: Deepak NATARAJAN, Coimbatore (IN); JanardhanReddy TRIPURAM, Telangana (IN); Aravind VAIDHYANATHAN, Chennai (IN); Vijayan RADHAKRISHNAN, Chennai (IN); Venkatesan M. SRIRAMAN, Chennai (IN); Sivasubramanian PARTHASARATHY, Muthialpet (IN); Kavitha PANNEERSELVAM, Chennai (IN)

(21) Appl. No.: 14/339,230

(22) Filed: Jul. 23, 2014

(51) Int. Cl. G06F 17/30

(52) U.S. Cl. CPC G06F 17/30997; G06F 17/30864; G06F 17/3053; G06F 17/30507

(57) ABSTRACT

An approach for implementing an asset exchange platform for identifying assets associated with a user and providing recommendations to exchange the assets. The approach includes identifying one or more digital assets associated with a user. The approach also includes processing metadata associated with the one or more digital assets using an exchange rule to determine one or more other digital assets, a parameter for initiating an exchange of the one or more digital assets for the one or more other digital assets, or a combination thereof. Further, the approach includes presenting the one or more other digital assets, the parameter, or a combination thereof to the user as an exchange recommendation.

### BACKGROUND INFORMATION

With proliferation of electronic user devices, users utilize the devices to access, utilize, or consume a variety of contents or assets (e.g., programs, applications, media contents, etc.), which may be available from various sources. For example, a user may utilize a device (e.g., a mobile phone, a laptop computer, a television (TV) set-top box, a video game console, etc.) to execute various computer programs, view videos (e.g., movies), listen to music albums, play video games, read literary works, or the like, where the assets may be related to work, education, entertainment, etc. In various scenarios, over time, a user may accumulate a library of assets on a given number of devices associated with the user. For instance, a user may purchase or download numerous video game programs for use on a game console, various productivity programs (e.g., for drawing, word processing, dictation, etc.) for a laptop computer, several movies on a TV set-top box, several electronic books (eBooks) on an electronic reader (eReader) device, or the like. Additionally, since some of the assets may be specific to certain device types, a user may have a plurality of the same assets for use on different devices. For example, a video game program may have different versions for use on a mobile phone and on a game console, or a word processing program may have different versions for different computer operating systems. However, as a user accumulates the assets, it is possible that he will not be able or care to utilize or consume them with much frequency, which can lead to a library of unused or seldom accessed assets.

Based on the foregoing, there is a need for identifying assets associated with a user and providing recommendations to exchange the assets.

### BRIEF DESCRIPTION OF THE DRAWINGS

Various exemplary embodiments are illustrated by way of example, and not by way of limitation, in the figures of the accompanying drawings in which like reference numerals refer to similar elements and in which:

FIG. 1 is a diagram of a system capable of identifying assets associated with a user and providing recommendations to exchange the assets, according to one embodiment;

FIG. 2 is a diagram of the components of an asset exchange platform, according to one embodiment;

FIG. 3 is a diagram of the components of a user device, according to one embodiment;

FIGS. 4 and 5 are flowcharts of processes for identifying assets associated with a user and providing recommendations to exchange the assets, according to various embodiments;

FIGS. 6A through 6D are diagrams of user interfaces for use in the processes of FIGS. 4 and 5, according to various embodiments;

FIG. 7 is a diagram of a computer system that can be used to implement various exemplary embodiments; and

FIG. 8 is a diagram of a chip set that can be used to implement an embodiment of the invention.

### DESCRIPTION OF THE PREFERRED EMBODIMENT

An apparatus, method and software for identifying assets associated with a user and providing recommendations or options to exchange the assets are described. In the following description, for the purposes of explanation, numerous specific details are set forth in order to provide a thorough understanding of the present invention. It is apparent, however, to one skilled in the art that the present invention may be practiced without these specific details or with an equivalent arrangement. In other instances, well-known structures and devices are shown in block diagram form in order to avoid unnecessarily obscuring the present invention. Further, the term “asset(s)” is used to refer to applications, programs, media contents, or similar software that may be executed, utilized, consumed, or accessed via a user device, wherein the assets may be stored at a local or at a remote storage device, which may be accessible to the user device. Furthermore, the terms “asset” and “content” may be used interchangeably to refer to a content item or an asset item.

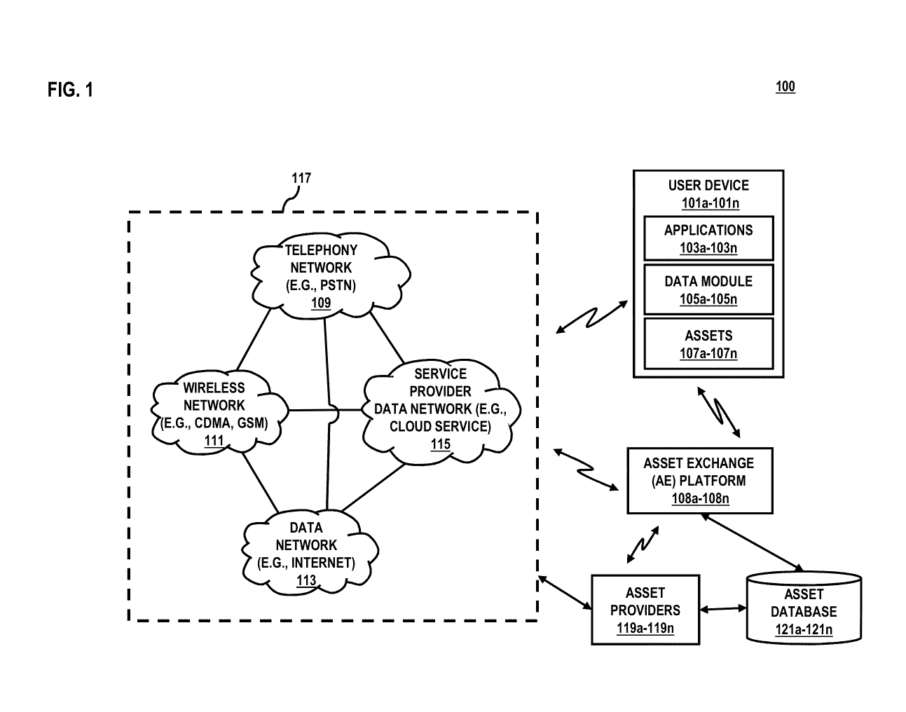

FIG. 1 is a diagram of a system for implementing a service for identifying assets associated with a user and providing recommendations to exchange the assets. In general, users utilize various electronic devices to execute or consume a variety of assets available from different sources. For example, a user may utilize a computer to execute different programs or applications or consume different media assets, which may be acquired by purchasing, renting, borrowing, for free, as a gift, or the like that may be available from various online or traditional sources (e.g., friends, content/asset providers, etc.) Usually, after some time, a user may accumulate a library of assets for or on the user devices that he utilizes, wherein the assets may be stored on a local user device or at a remote storage device (e.g., cloud computing.) Additionally, the assets may include different versions of a same asset that are for use on specific user devices (e.g., mobile phones, computers, game consoles, etc.) In some instances, users may or may not be familiar with the assets that they purchase or rent. For example, a user renting a new media asset (e.g., a movie, music, eBook, etc.) may not be familiar with the asset or may be mistaken as to a selected asset. However, in most scenarios a user may not be able to return or exchange an asset that he no longer uses, wishes to use, or an asset that is seldom used or forgotten about. Further, as users may be overwhelmed and unable to track all the assets that they may have, the users may be unwilling or less likely to seek additional assets. Nevertheless, asset or service providers may be able to provide additional assets that may be of interest to the users for productivity, education, entertainment, or the like.

Therefore, there is a need for a capability to identify assets associated with a user and provide recommendations to exchange the assets for other assets or for other incentives provided by an asset or a service provider.

To address these issues, system 100 of FIG. 1 provides the capability for identifying assets associated with a user and providing recommendations to exchange the assets. As previously discussed, in some situations, a user may have access rights to a variety of assets for use on one or more user devices. In various scenarios, the access rights may be effectuated via digital rights management (DRM) for long term, short term, or permanent access to the assets, which may be associated with a user or his user devices, wherein owners, producers, publishers, sellers, etc. of the assets may utilize various DRM technologies to control access to their assets, e.g., after a sale or rental instance. In some instances, a user may wish to exchange an asset or the rights to the asset for other assets or rights to other assets. In some scenarios, a service or an asset provider may be able to track assets of a user or the access/usage of the assets by the user and provide various recommendations to the user for exchanging the asset items or the rights to the asset for other asset or rights to other asset.

In one embodiment, an asset exchange (AE) platform may interact with a user for permission to track or identify information about the user's assets or asset usage and provide to the user one or more exchange recommendations, which may be available from one or more service or asset providers. For example, an AE platform may provide analytics about a user's assets or content usage to a content/asset/service provider so that the asset provider may determine and recommend various options for exchanging one or more assets associated with the user. Further, the AE platform may present the recommendations to the user, or the asset provider may directly present the recommendations to the user at a user device. In one embodiment, the user may remain anonymous to an asset provider and interact only with an AE platform.

In one embodiment, a user may subscribe to services provided by an AE platform, wherein user profile, user preferences, or the like information may be utilized by the AE platform to provide recommendations, options, offers, or the like that may be available for exchanging assets associated with the user. For example, user information may indicate user devices associated with the user, user preferences with respect to asset types, frequency of asset analytics determined by the AE platform, or the like.

In one embodiment, the user may be associated with a specific library wherein the assets therein may be candidates for exchange. For example, a user may setup a storage location (e.g., remote or local) where the actual assets or links to the assets allowed for exchange may be stored.

In various scenarios, the assets may include asset information about the ownership of the assets, ratings by the user, frequency of use/access, purpose of the assets (e.g., work, entertainment, education, etc.), or the like, wherein the asset information may be utilized in an AE platform analytics.

In one embodiment, a user may initiate a request for exchange on a per asset basis. For example, a user may request to exchange an asset soon after acquiring a media item, a video game, an eBook, or the like.

In various embodiments, an AE platform may utilize analytics associated with assets of a user and analytics of asset providers or other users (e.g., market information) for determining and presenting one or more recommendations to the user for exchanging an asset associated with the user. For example, an AE platform may determine a rating/value of an asset based on information available from asset providers or other users to determine a value for the asset associated with the user.

For the purpose of illustration, the system 100 may include one or more user devices 101a-101n (user device 101), which may include, execute, and utilize one or more applications 103a-103n (also referred to as applications 103), one or more data collection modules 105a-105n (also referred to as data module 105), and assets 107a-107n (also referred to as assets or assets 107.) Additionally, the system 100 may include one or more asset exchange platforms 108a-108n (also referred to as AE platform 108), which may implemented as a standalone platform or as an integrated component of an asset or a service provider in the network system 117. In one embodiment, an AE platform 108 may be implemented by a local service provider (e.g., a retailer, at a shopping mall, etc.), which may be utilized to determine analytics associated with assets on a user device of a user and provide recommendations, offers, options, or the like to exchange an asset at the user device with other assets or incentives offered by the local service provider. In one embodiment, a local AE platform may be implemented in conjunction with a remote AE platform for combining and presenting recommendations, information, offers, or incentives available from a remote asset producer (e.g., an asset provider) and a local asset vendor (e.g., a retail store.)

Further, the system 100 may include a network system 117, which may include one or more networks, including a telephony network 109, a wireless network 111, a data network 113, a service provider data network 115, etc. By way of example, the networks 109, 111, 113, and 115 may be any suitable wireline and/or wireless network, which may be managed by one or more service providers. In one example, the networks 109, 111, 113, and 115 may be one or more elements in a network system 117, which may include various components and elements for providing a range of communication and network services. For example, telephony network 109 may include a circuit-switched network, such as the public switched telephone network (PSTN), an integrated services digital network (ISDN), a private branch exchange (PBX), or other like network. Wireless network 111 may employ various technologies including, for example, code division multiple access (CDMA), enhanced data rates for global evolution (EDGE), general packet radio service (GPRS), mobile ad hoc network (MANET), global system for mobile communications (GSM), Internet protocol multimedia subsystem (IMS), universal mobile telecommunications system (UMTS), etc., as well as any other suitable wireless medium, e.g., microwave access (WiMAX), wireless fidelity (WiFi), satellite, and the like. Meanwhile, data network 113 may be any local area network (LAN), metropolitan area network (MAN), wide area network (WAN), the Internet, or any other suitable packet-switched network, such as a commercially owned, proprietary packet-switched network, such as a proprietary cable or fiber-optic network.

Although depicted as separate entities, networks 109, 111, 113, and 115 may be completely or partially contained within one another, or may embody one or more of the aforementioned infrastructures. For instance, the service provider network 115 may embody circuit-switched and/or packet-switched networks that include facilities to provide for transport of circuit-switched and/or packet-based communications. It is further contemplated that networks 109, 111, 113, and 115 may include components and facilities to provide for signaling and/or bearer communications between the various components or facilities of system 100. In this manner, networks 109, 111, 113, and 115 may embody or include portions of a signaling system 7 (SS7) network, or other suitable infrastructure to support control and signaling functions.

In one embodiment, the system 100 may include one or more asset providers 119a-119n (asset providers 119) that may include and/or have access to one or more asset database 121a-121n (asset database 121), which may store, include, and/or have access to various, asset, asset items, asset information, incentives, offers, discounts, or the like. For example, the asset providers 119 may store assets at the asset database 121 provided by various users, asset producers, asset producers, asset publishers, various service providers, crowd-sourced asset, and the like. Further, a service providers 115 and/or the asset providers 119 may utilize one or more service application programming interfaces (APIs)/integrated interface, through which communication, media, assets, and information (e.g., associated with users, applications, services, assets, etc.) may be shared, accessed and/or processed. In various embodiments, the asset providers 119 may interact with the AE platforms 108 directly or via the network system 117. For example, an asset provider 119 may request and utilize services offered by an AE platform 108 in order to effectuate communication and exchange of assets with a user device 101. In one embodiment, an AE platform 108 may be partially or completely implemented as a component of an asset provider 119.

By way of examples, the user devices 101 may communicate with other devices via one or more proximity-based communication channels or via one or more network service providers in the network system 117. Further, the applications 103 may include various applications for productivity, education, entertainment, social networking, web browser, communications, asset sharing, multimedia applications, user interface (UI), map application, web client, or the like.

In one embodiment, a user device 101 may utilize a data module 105 for determining/collecting data or asset associated with the user device 101, one or more users of the user device 101, the applications 103, assets 107 or the like. In addition, the user device 101 can execute an application 103 that is a software client for storing, processing, and/or forwarding one or more information items to other components of the system 100. In various embodiments, the data module 105 may include various sensors for detecting and capturing various signals, information, and assets, for example, audio, video, location information, Bluetooth signals, near field communication (NFC) signals, wireless local area network (WLAN) signals, RFID signals, or the like. Further, the collected information, asset, or signals may be shared, via the applications 103 with other user devices 101, AE platforms 108, or service providers in the network system 117.

It is noted that user devices 101 may be any type of mobile terminal, fixed terminal, or portable terminal including a mobile handset, station, unit, device, multimedia computer, multimedia tablet, Internet node, communicator, desktop computer, laptop computer, Personal Digital Assistants (PDAs), smartphone, set-top box, TV set, or any combination thereof. It is also contemplated that the user devices 101 can support any type of interface for supporting the presentment or exchanging of data. In addition, user devices 101 may facilitate various input means for receiving and generating information, including touch screen capability, keyboard and keypad data entry, voice-based input mechanisms and the like. Any known and future implementations of user devices 101 are applicable. In certain embodiments, user devices 101 may be configured to establish peer-to-peer communication sessions with each other using a variety of technologies, including near field communication (NFC), Bluetooth, ZigBee, infrared, etc. Also, connectivity can be provided via a wireless local area network (LAN). By way of example, a group of user devices 101 may be configured to a common LAN so that each device can be uniquely identified via any suitable network addressing scheme.

In various embodiments, the user devices 101 may communicate with one or more components of the system 100 (e.g., an AE platform, another user device, etc.) via one or more proximity-based communication methods and protocols. For example, the communication may be via Bluetooth®, a wireless local area network (WLAN), or other available communication methods. In various examples, the user devices 101 may communicate with one or more networks and service providers of the network system 117 to provide information and/or request information or services from the service providers. In various scenarios, the applications 103 or the data module 105 may determine information associated with one or more processes, applications, assets 107, UI presentation options, available device options, available functionalities, user profile, user preferences, user configuration, device configuration, or the like.

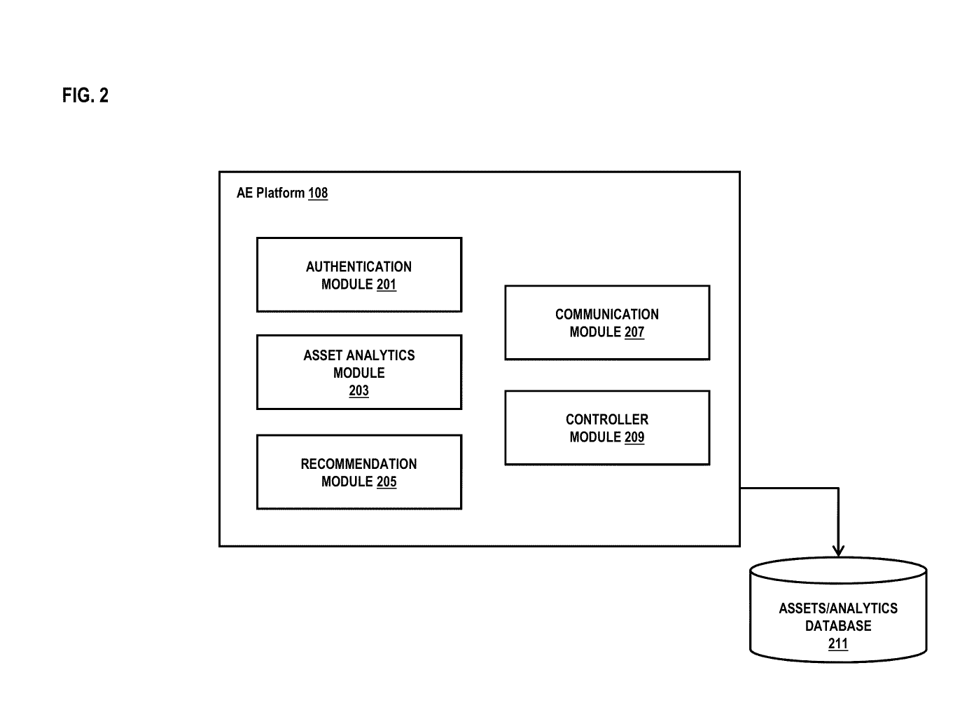

FIG. 2 is a diagram of the components of an asset exchange platform, according to one embodiment. The AE platform 108 includes various executable modules for performing one or more computing, data processing and network based instructions that in combination provide a means of identifying assets associated with a user and providing recommendations to exchange the assets. Such modules can be implemented in hardware, firmware, software, or a combination thereof. By way of example, the AE platform 108 may include an authentication module 201, asset analytics module 203, recommendation module 205, communication module 207, and a controller module 209. In addition, the AE platform 108 may have access to or maintain an asset/analytics database 211, wherein the asset may be requested or received from one or more asset or service providers. Further, the AE platform 108 may store asset analytics or assets in the asset/analytics database 211.

In one embodiment, an authentication module 201 may operate in conjunction with the controller module 209 to authenticate users and user devices 101a-101n for interaction with the AE platform 108. By way of example, the authentication module 201 receives a request from a user of a device 101 to subscribe to the AE platform 108 service for enabling identification of assets associated with the user and providing recommendations to exchange the assets. The subscription process may include enabling discovery of and communication between the user device 101 and an AE platform 108. Other settings may include specifying a method for communicating asset information, recommendations, offers, or the like to the user device 101, such as e-mail, short messaging service (SMS), or as a web-based communication. Additionally, various capabilities of the user device 101 may be determined, for example, in relation to asset utilization, asset execution, asset consumption, media asset presentation, user interface, processing power, or the like.

The authentication process performed by the authentication module 201 may also include receiving and validating a login name and/or user identification value as provided or established for a particular user during a subscription or registration process with the AE platform 108. The login name and/or user identification value may be received as input provided by the user from the user device 101. Alternatively, the login process may be performed through automated association of profile settings maintained by the AE platform 108, or one or more other service/asset providers. For example, a user device information may include an identification signal generated by an active user device, i.e., a carrier detection signal, IP address, mobile directory number (MDN), subscriber identity module (SIM) (e.g., of a SIM card), radio frequency identifier (RFID) tag, or customer identifier value determined from one or more other user accounts at one or more service/asset providers. By way of example, the authentication module 201 may utilize one or more validated user information items to initiate one or more interactions with one or more other service providers associated with one or more user accounts at, for example, a bank, a communication service provider, a physical-location or on-line retailer, or the like.

In one embodiment, an asset analytics module 203 may operate in connection with the controller module 209 to enable one or more processes for identifying assets associated with a user or a user device 101. In various scenarios, the assets may include executable programs, software, applications, widgets, etc., or consumable media assets items (e.g., movies, music, literary works, etc.) By way of example, the assets associated with a user or a user device may be stored at one or more local or a remote storage devices, wherein the asset analytics module 203 may access the storage devices for analyzing the assets or information about the assets. For example, asset analytics module 203 may access a local storage at a user's computer and analyze the programs and media assets thereon, wherein the analysis may indicate that acquisition dates of the assets (e.g., purchase, rent, lease, etc.), types of the assets, frequency of use, consumption rate, ratings by of the assets by the user, or the like. In one embodiment, the asset analytics module 203 can determine the consumption rate of a media asset that is on rent or lease. For example, the asset analytics module 203 can determine what portion of a rental movie (e.g., for digital access) has a user consumed/watched so that a proportionate incentive (e.g., credit) may be recommended to the user if the user wishes to or requests to exchange the rental movie for another movie or asset (e.g., a video game.) In one scenario, a user may indicate to the AE platform 108 certain assets that the user wishes to analyze for potential exchanging (e.g., a wish list) with other assets or incentives that may be available from one or more asset or service providers. For example, the user may own several old movies that the user may wish to trade for other movies. In one scenario, a user may wish to exchange a movie that he has recently purchased or rented. In various embodiments, the AE platform 108 may utilize information available from various users or asset/service providers to determine a rating or a value associated with an asset. For example, the information may indicate that certain number of users give a three-star (e.g., three out of five) rating to a particular video game program. In one example, the information may indicate that an asset provider may provide certain incentives for exchanging an asset with the asset provider. In one embodiment, the AE platform 108 may access and analyze assets associated with a plurality of users (e.g., family members, friends, colleagues, classmates, etc.) and user devices. For example, several family members may have movies, games, applications, or the like that may be on different devices (e.g., computers, TV set-top boxes, game consoles, etc.), which are associated with the family members. In one embodiment, the asset analytics module 203 may identify, group, and analyze different assets associated with different users or user devices for providing recommendations for exchange.

In one embodiment, the recommendation module 205 may operate in conjunction with the asset analytics module 203 and the controller module 209 to determine and provide one or more recommendations to a user for exchanging one or more assets that are associated with the user for one or more other assets or incentives that may be available from one or more asset or service providers. In one embodiment, the recommendation module 205 may operate in conjunction with the asset analytics 203 and the communication module 207 for determining and communicating one or more recommendations for exchanging one or more assets associated with a user or a user device. In one embodiment, the recommendation module 205 may provide one or more asset exchange recommendations based on comparison of the analytics from the asset analytics module 203 associated with assets at a user device with asset exchange offers/information available from one or more asset or service providers. In various scenarios, the recommendations may be for exchanging an asset with an asset/service provider originally associated with that asset or with a different asset/service provider. For example, asset purchased, rented, or leased from a first asset provider may be exchanged with the same or a different asset provider. In various scenarios, the recommendation module 205 may utilize additional user information (e.g., user profile, user preferences, etc.) for determining and providing a recommendation to that user. In one example, the recommendation module 205 may determine and provide a recommendation for exchanging an asset based on one or more incentives/offers provided by one or more asset/service providers, location information of the user, date, time, day of the week, season of the year, holidays, mood of the user, an event associated with the user, or the like. For example, information that a user is on summer vacation visiting an island destination may be used to determine and provide a recommendation for exchanging several older music albums for a newer and lively music album suitable for the occasion. In another example, the recommendation module 205 may determine that the user is a student preparing for final exam and provide a recommendation to the user to exchange several movies owned by the user with use or certain study guides for a limited time (e.g., rent).

In one embodiment, the communication module 207 may be utilized to communicate with various components of the system 100 or with the modules of the AE platform 108. In one embodiment, the communication module 207 may utilize one or more communication channels to communicate information for identifying assets associated with a user and providing recommendations to exchange the assets. By way of example, the communication module 207 executes various protocols and data sharing techniques for enabling collaborative execution between a user device 101 and the AE platform 108.

In one embodiment, a controller module 209 is configured to operate and effectuate the processes by or at the other modules of the AE platform 108. For example, the controller module 209 may generate the appropriate signals to control the communication module 207 for facilitating transmission of information over the network system 117 or to the other modules of the AE platform 108. In one embodiment, the controller module 209 may effectuate execution of one or more algorithms for performing one or more processes at or by the other modules of the AE platform 108.

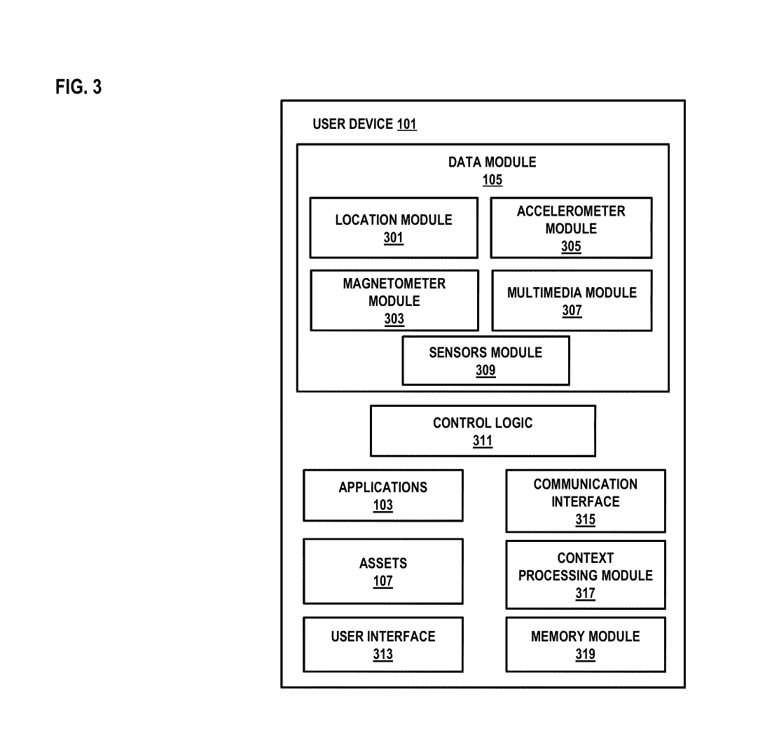

FIG. 3 is a diagram of the components of a user device, according to one embodiment. By way of example, a user device 101 includes one or more components for executing various applications, enabling various functionalities, and for communicating with other user devices 101 or with other components of the system 100. It is contemplated that the functions of these components may be combined in one or more components or performed by other components of equivalent functionality. In one embodiment, the user device 101 includes a data module 105, which may include one or more location modules 301, magnetometer modules 303, accelerometer modules 305, multimedia module 307, and sensors module 309. Further, the user device 101 may also include control logic 311 to coordinate the use of other components of the user device 101, a user interface 313, a communication interface 315, a context processing module 317, and a memory module 319. The applications 103 and the assets 107 may execute on the control logic 311 utilizing the components of the user device 101.

The location module 301 can determine a user's location, for example, via location of a user device 101. The user's location can be determined by a triangulation system such as GPS, assisted GPS (A-GPS), Cell of Origin, or other location extrapolation technologies. Standard GPS and A-GPS systems can use satellites to pinpoint the location of a user device 101. A Cell of Origin system can be used to determine the cellular tower that a cellular user device 101 is synchronized with. This information provides a coarse location of the user device 101 because the cellular tower can have a unique cellular identifier (cell-ID) that can be geographically mapped. The location module 301 may also utilize multiple technologies to detect the location of the user device 101. Location coordinates (e.g., GPS coordinates) can give finer detail as to the location of the user device 101 when media is captured. In one embodiment, GPS coordinates are stored as context information in the memory module 319 and are available to the context processing module 317, the data module 105, and/or to other entities of the system 100 (e.g., via the communication interface 315.) Moreover, in certain embodiments, the GPS coordinates can include an altitude to provide a height. In other embodiments, the altitude can be determined using another type of altimeter.

The magnetometer module 303 can be used in finding horizontal orientation of the user device 101. A magnetometer is an instrument that can measure the strength and/or direction of a magnetic field. Using the same approach as a compass, the magnetometer is capable of determining the direction of a user device 101 using the magnetic field of the Earth. The front of a media capture device (e.g., a camera) can be marked as a reference point in determining direction. Thus, if the magnetic field points north compared to the reference point, then the angle of the user device 101 from the magnetic field is known. Simple calculations can be made to determine the direction of the user device 101. In one embodiment, horizontal directional data obtained from a magnetometer can be stored in memory module 319, made available to other modules and/or applications 103 of the user device 101, and/or transmitted via the communication interface 315 to one or more entities of the system 100.

The accelerometer module 305 can be used to determine vertical orientation of the user device 101. An accelerometer is an instrument that can measure acceleration. Using a three-axis accelerometer, with axes X, Y, and Z, provides the acceleration in three directions with known angles. Once again, the front of a media capture device can be marked as a reference point in determining direction. Because the acceleration due to gravity is known, when a user device 101 is stationary, the accelerometer module 305 can determine the angle the user device 101 is pointed as compared to Earth's gravity. In certain embodiments, the magnetometer module 303 and accelerometer module 305 can be means for ascertaining a perspective of a user. This perspective information may be stored in the memory module 319, made available to other modules and/or applications 103 of the user device 101, and/or sent to one or more entities of the system 100.

In one embodiment, the multimedia module 307 may be utilized to generate, receive, or consume, etc. various media items, for example, images, video, audio, text, and the like. In various embodiments, the media items may be shared with the applications 103, which in turn may share one or more information items about the media items with one or more components of the system 100. In various embodiments, the multimedia module 307 may interface with various sensors; for example, a camera, a microphone, etc., to determine additional contextual information associated with a media asset, a code associated with a media content item, or the like.

In various embodiments, the sensors module 309 can process sensor data from various sensors (e.g., microphone, optical, Bluetooth, NFC, GPS, accelerometer, gyroscope, thermometer, etc.) to determine environmental (e.g., atmospheric) conditions surrounding the user device 101, user mood, location information, and various other information from a range sensors that may be available on one or more devices. For example, the sensors module 309 may detect conditions including humidity, temperature, geo-location, biometric data of the user, etc. Once again, this information can be stored in the memory module 319 and sent to the context processing module 317 and/or to other entities of the system 100. In certain embodiments, information collected from the data module 105 can be retrieved by the control logic 311 and stored at the memory module 319, made available to other modules and/or applications 103 of the user device 101, and/or sent to one or more entities of the system 100.

The user interface 313 can include various methods for a user to interface with applications, modules, sensors, and the like at a user device 101. For example, the user interface 313 can have outputs including a visual component (e.g., a screen), an audio component, a physical component (e.g., vibrations), and other methods of communication. User inputs can include a touch-screen interface, a scroll-and-click interface, a button interface, a microphone, etc. An input may be via one or more methods such as voice input, textual input, typed input, typed touch-screen input, other touch-enabled input, graphical user interface (GUI), etc.

In one embodiment, the communication interface 315 can be used to communicate with one or more entities of the system 100, for example, to submit a request for and receive an asset item from various asset providers. In various embodiments, the communication interface 315 may facilitate communications via one or more wireless communication channels and protocols, for example, WLAN, RFID, NFC, Bluetooth Smart, Bluetooth, Ant+, Z-Wave, ZigBee, or the like, wherein the communication channels may be established via one or more sensors, transceivers, transmitters, receivers, wireless charging interface, or the like. Certain communications can be via methods such as an internet protocol, messaging (e.g., SMS, multimedia messaging service (MMS), etc.), or any other communication method (e.g., via the network system 117). In some examples, the user device 101 can send context information associated with the user device 101 or its assets 107 to other user devices 101 and/or to other entities of the system 100. In one embodiment, the communication interface 315 may interact with the communication module of the AE platform 108 in order to effectuate a communication of one or more information items, interaction indicators, interaction options, command messages, or the like.

The context processing module 317 may be executing on the control logic 311 for determining context information from the data module 105, the applications 103, or the assets 107. This information may be transmitted, via the communication interface 315, to one or more user devices 101 and/or to other entities of the system 100. The context processing module 317 may additionally be utilized as a means for determining information related to the user, an instance of data, a value, a process, an asset, an object, a subject, that an application 103 is being executed, and the like. In certain embodiments, the context processing module 317 can infer higher level context information from the context data such as activity at a user device 101, user information, etc. In one example, contextual information associated with one or more media items, consumption of a media item, one or more interactions with assets 107, or the like may be determined and shared with one or more local or network-based asset or service providers.

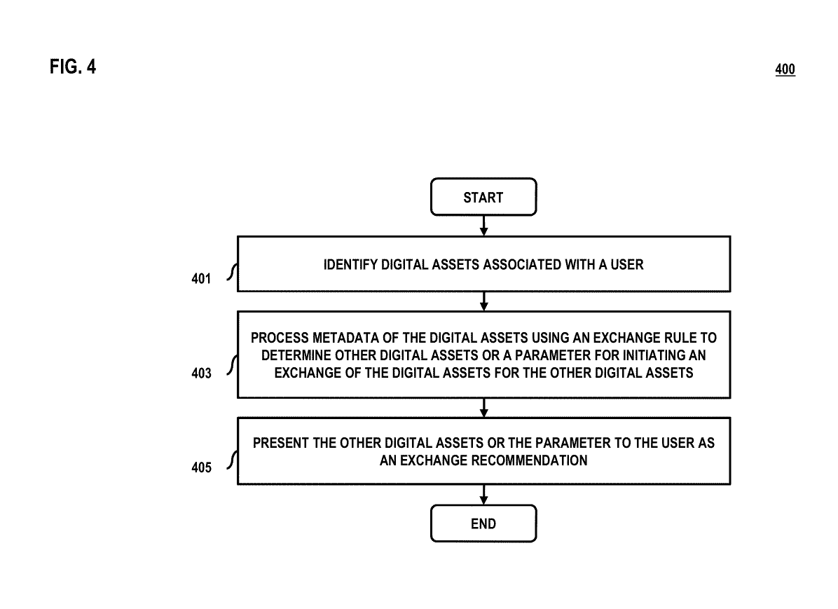

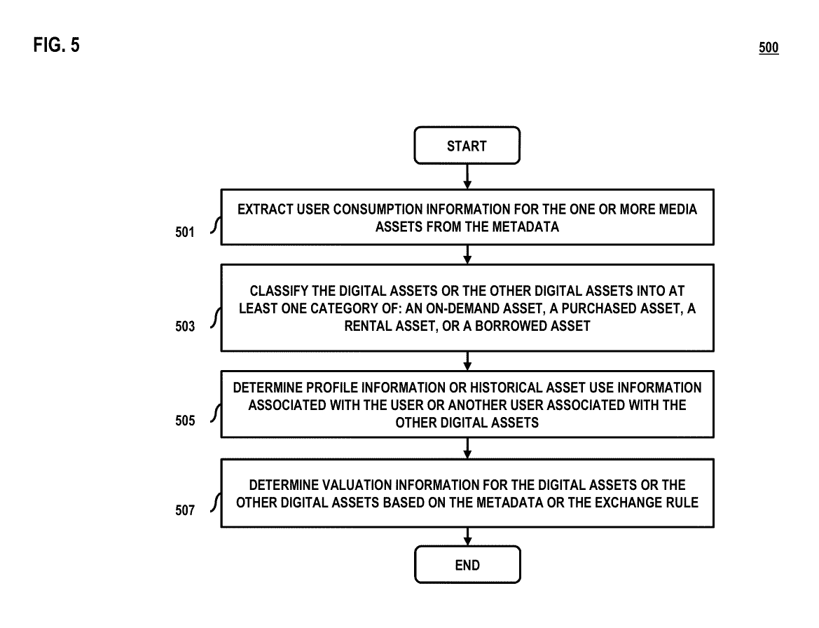

FIGS. 4 and 5 are flowcharts of processes for identifying assets associated with a user and providing recommendations to exchange the assets, according to various embodiments. It is noted that the steps of processes 400 and 500 may be performed in any suitable order as well as combined or separated in any suitable manner. Further, all or portions of the steps or the processes may be initiated or completed by any of the components of the system 100, for example, by an AE platform 108. However, for clarity in discussing the processes, the AE platform 108 is referred to as completing various steps of said processes, which may be performed in any suitable order and where one or more of the steps may be optional.

Referring to FIG. 4, in step 401, the AE platform 108 may identify one or more digital assets associated with a user. In one embodiment, an AE platform 108 may utilize one or more programs, algorithms, applications, or the like to access or interact with a user device 101 to identify the one or more digital assets that may be associated with the user device 101 or a user of the user device 101. In one embodiment, a user device 101 may subscribe for services to an AE platform 108 for continuous (e.g., weekly, monthly, etc.) services. For example, a user may request or agree for an AE platform 108 to track and identify information about digital assets associated with the user or with one or more user devices 101 that are associated with the user. In one embodiment, a user may submit a request for service to an AE platform 108 on an as-needed basis. For instance, a user may submit a request to an AE platform 108 for exchange services on one or more digital assets. In one embodiment, an asset or a service provider may determine a user request for a digital assets exchange service, wherein the asset or the service provider may forward the user request or submit a new request (e.g., based on the user request) to the AE platform 108 so that the AE platform 108 may provide the exchange service directly to the user or to the asset/service provider. For example, a user may wish to explore the possibility of exchanging one or more digital assets with an asset or a service provider, wherein the asset or the service provider may submit a request to an AE platform 108 for processing. In various scenarios, an AE platform 108 may utilize user information (e.g., user/device profile, user account, etc.) to identify the user or to identify the digital assets that may be associated with the user or the user device. In one embodiment, a user may convert an existing asset from one format (e.g., non-digital media item) or import an existing digital asset stored on a different medium (e.g., a compact disc) and store the existing asset in a digital format at a user device 101 or a storage device so that an AE platform 108 can access or identify the converted or imported digital asset. For example, a user may own a movie or a video game that is on a compact disc, wherein a conversion or an importing of the movie or the video game to a user device 101 may also include or require the DRM information associated therewith.

In step 403, the AE platform 108 may process metadata associated with the one or more digital assets using an exchange rule to determine one or more other digital assets, a parameter for initiating an exchange of the one or more digital assets for the one or more other digital assets, or a combination thereof. In one embodiment, the metadata may include asset rating information, asset age information, asset popularity information, asset scheduling information, asset availability information, or a combination thereof. In one scenario, the metadata may be determined from a user device 101 or a storage device that the assets are stored thereon. In one scenario, the metadata may be determined from a library or a list associated with a user account or the assets that are associated with the user account. In one embodiment, the metadata may be provided by or via a service or an asset provider that is associated with the user account or a user device. In various scenarios, one or more information items in the metadata may be determined (e.g., tagged, appended, noted, etc.) by a user, an application 103, a data module 105, or the like at the user device 101. In one embodiment, the exchange rule may specify a one-to-one asset exchange, a many-to-one asset exchange, a many-to-many asset exchange, or a combination thereof. In various scenarios, one or more exchange rules may be determined or provided by a service or an asset provider, a user associated with the assets, an AE platform 108, or the like. For example, a user may give a high or a low rating to a video game or a movie based on his liking the video game or the movie. In one embodiment, an AE platform 108 may the metadata and the exchange rule to identify one or more other digital assets that may be of interest to one or more users associated with the one or more existing digital assets. For example, the metadata and the exchange rule may indicate that several new movies may be of interest to a user who has several existing movies in similar genres. In one example, the AE platform 108 may have access to a library or a list of assets that one or more users, asset providers/owners, etc. may wish to make available for exchange with other assets. Additionally, the AE platform 108 may utilize one or more parameters for initiating process to exchange an existing digital asset with another digital asset. For example, the parameters may indicate as to the value applied to the existing digital asset, how many existing digital assets may be needed for the exchange, what discounts or offers may be available from an asset or service provider for a possible exchange, or the like. In one example, the value may be determined based on information or ratings by the user of an asset, one or more other users who also may own, be familiar with, or wish to access the asset; by one or more asset or service providers; asset producers/publishers/distributors, or the like.

In step 405, the AE platform 108 may present the one or more other digital assets, the parameter, or a combination thereof to the user as an exchange recommendation. In one embodiment, the an AE platform 108 may initiate or continue with a process for an asset exchange and present to a user (e.g., via a user interface at a use device 101) one or more recommendations to exchange one or more current/existing assets for one or more other assets that may be available from one or more asset or service providers, other users, asset owners, asset producers, or the like. In various embodiments, a recommendation may include one or more parameters indicative of a value determined (e.g., by an asset provider, by other users, etc.) for a user's current asset, status of the asset (e.g., age, version, etc. compared to an asset available for exchange), frequency of use by the user, compatibility with the user's devices (e.g., current or future), expiration of a DRM license (e.g., as applicable), possible future decline/increase in value of the asset, or the like. In one scenario, an exchange recommendation may include information about various other assets that may be available from various sources for the exchange. In one embodiment, the recommendation may include analysis of several offers/incentives that may be available from various asset/service providers, other users, asset publishers, etc.

In one embodiment, once a user chooses/agrees to an exchange of an existing digital asset (e.g., for another digital asset, for credit, etc.), then an AE platform 108 may access and retrieve a digital folder or file associated with the existing digital asset, which may be stored at a user device 101 or at another storage device. For example, the AE platform 108 may upload a digital file of a video game that is stored on a game console associated with the user. In one embodiment, in addition to or instead of retrieving a file/folder of an existing digital asset that is to be exchanged, the AE platform may access and retrieve a DRM license that is associated with the existing digital asset or with a user associated with the existing digital asset. For example, the AE platform 108 may upload the digital file(s) of a computer program that is to be exchanged as well as uploading the DRM license associated with the computer program. In one embodiment, in addition to or instead of retrieving an existing digital asset or its DRM license that is to be exchanged, an AE platform 108 may cause a deletion/invalidation of the digital asset and/or its DRM license, which may be stored at one or more user devices 101 or storage devices that are associated with the user of the digital asset. For example, the AE platform 108 may not require an upload of the digital asset or its DRM file(s), and instead, the AE platform 108 may send a command/request to the user device 101 or the storage device to cause a deletion of the digital asset or its DRM license file. In one embodiment, in addition to or instead of retrieving an existing digital asset or its DRM license that is to be exchanged, an AE platform 108 may request for a user agreeing to the exchange to forward to a content/service provider (e.g., associated with the AE platform 108 or an exchange) one or more physical mediums that may be associated with the digital asset or its DRM license. For example, an AE platform may request for the user to send to a content provider any compact discs, video tapes, user manuals, posters, or other material that may be associated with an asset that is to be exchanged. In various embodiments, an AE platform 108 may store, forward, utilize, exchange, or otherwise manage an asset, the DRM license or other material associated with the asset. For example, the AE platform may forward a digital file and the DRM license information/file of a video game to a content provider.

Referring to FIG. 5, in step 501, the AE platform 108 may extract user consumption information for the one or more digital assets from the metadata, wherein the one or more other digital assets, the parameter, or a combination thereof are further determined based on the consumption information. In one scenario, an AE platform 108 may determine from the metadata a rate, frequency, extent, etc. of access or consumption information that is associated with a digital asset. For example, the consumption information may indicate that a user has watched the first 20 minutes of a certain movie, has listened to a certain music album five times in two weeks, has used a certain drawing program once in six months, or the like. In one embodiment, the consumption information may be utilized to determine one or more parameters associated with exchanging one asset with another asset. For example, a parameter may indicate that if the consumption rate of a media asset increases/continues, then the value of the asset for an exchange may decline. In one scenario, if a user wishes to exchange a video on demand (VOD), then the value of the VOD may decline if the user initiates or continues to watch the VOD, and the parameters may indicate that the VOD would be most valuable if it is exchanged within the next 10 minutes. In one example, certain assets may be associated with limited or restricted access time, which may be used to determine availability of other assets for exchange.

In step 503, the AE platform 108 may classify the one or more digital assets, the one or more other digital assets, or a combination thereof into at least one category of: an on-demand asset, a purchased asset, a rental asset, a borrowed asset, or a combination thereof, wherein the one or more other digital assets, the parameter, or a combination thereof are further determined based on the at least one category. In one scenario, an AE platform 108 may utilize information about DRM, licensing, ownership, status, or the like, which may be used to categorize an existing asset for consideration in exchanging with another asset. For example, an asset in a rental category may indicate that the asset is associated with restrictions or limitations when considered for an exchange. In one example, a purchased asset may be available for exchange with a plurality of other parties and other assets without limitations or restrictions other than what is determined by the AE platform 108 or the user/owner of the asset. In one scenario, an asset associated with a different user (e.g., a friend, a company, a family member, etc.) may be categorized as a borrowed asset, which may require additional DRM information to be considered for an exchange with another asset. In various embodiments, the effects of categorization of an asset on an exchange may be presented to the user by providing additional information in the parameters or with the other assets that may be available for exchange. For example, an exchange recommendation for an asset in a category of “borrowed” may indicate that the asset is not eligible for exchange; however, if the user was to obtain additional DRM information, then certain parameters or other assets may be available for the exchange.

In step 505, the AE platform 108 may determine profile information, historical asset use information, or a combination thereof associated with the user, another user associated with the one or more other digital assets, or a combination thereof, wherein the one or more other digital assets, the parameter, or a combination thereof are further determined based on the profile information, the historical asset use information, or a combination thereof. In one embodiment, user profile information may be determined from a user account associated with an AE platform 108, an asset or a service provider, a user device, or the like. Additionally, historical asset use or exchange information, which can be determined from a user account associated with an AE platform 108, an asset or service provider, a user device, or the like, can be used to determine parameters and other assets that may be available in an exchange of an existing asset. For example, a historical asset use may indicate that a user is prone to exchange video games every six months. In one scenario, the AE platform 108 may utilize profile or historical asset information of another user of another asset for determining the parameters or other assets in an exchange of an existing asset of a user.

In step 507, the AE platform 108 may determine valuation information for the one or more digital assets, the one or more other digital assets, or a combination thereof based on the metadata, the exchange rule, or a combination thereof, wherein the parameter for initiating the exchange is further determined based on the valuation information. In various embodiments, a valuation for a user's current asset or other assets for a possible exchange may be determined by an asset provider, by other users, by resellers, based on one or more markets, rating groups/agencies, or the like. Additionally, the valuation may be based on the metadata indicative of a frequency of use of an asset, user device compatibility, status of DRM license, age of the asset, or the like.

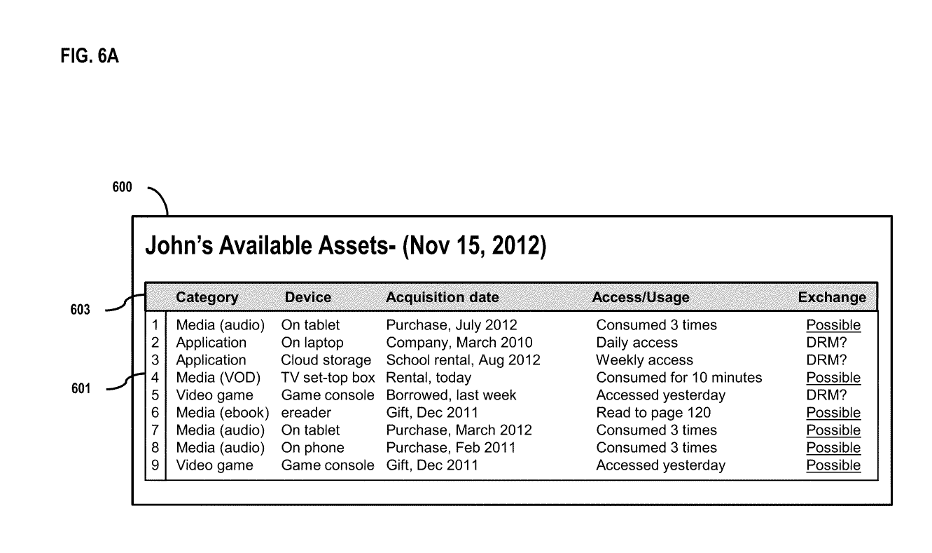

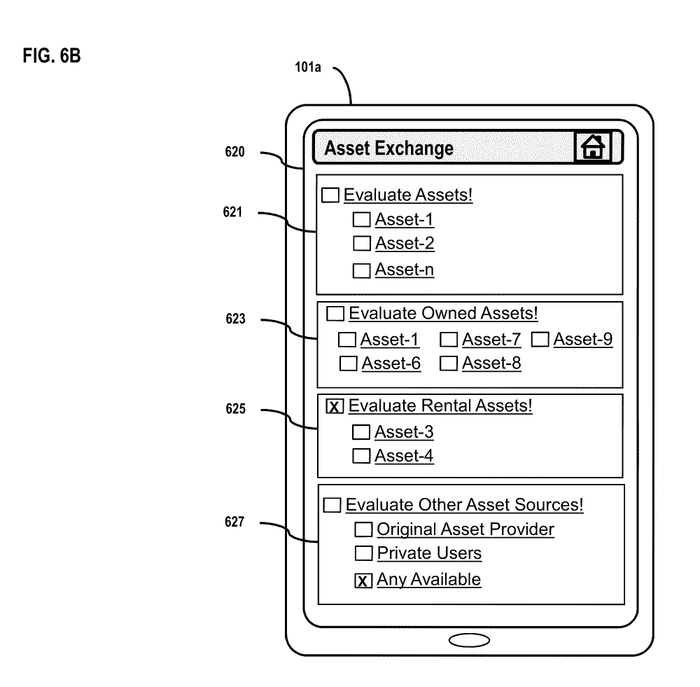

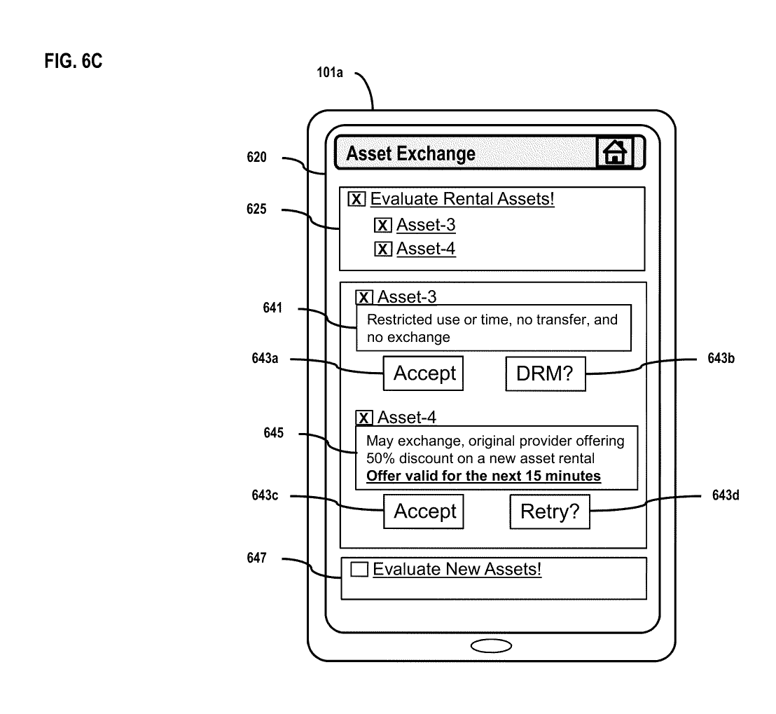

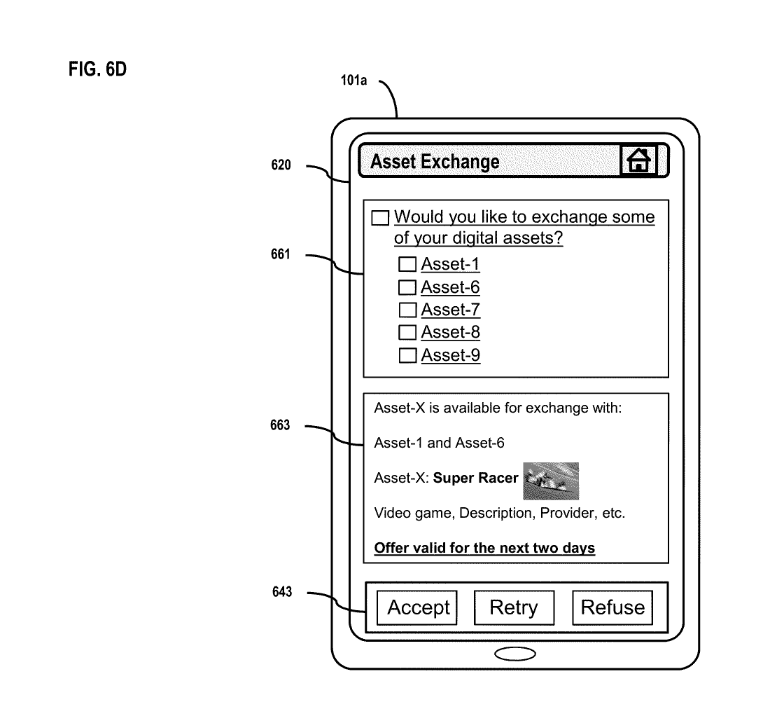

FIGS. 6A through 6D are diagrams of user interfaces for use in the processes of FIGS. 4 and 5, according to various embodiments.

FIG. 6A includes an illustration of a list 600 of assets that are associated with a user. In various embodiments, an AE platform 108 may determine the listing 600, which may be generated based on a request by a user, a notification from a user device 101 or a cloud computing service, a request from an asset/asset/service provider, or the like. In one example, the list 600 may include a listing of various assets 601, as of a certain date, which may be associated with a user “John.” Further, the assets in the listing 601 may be classified according to 603 as to a category (e.g., a media item, an application, etc.), user device type (e.g., laptop, mobile phone, set-top box, etc.), acquisition date, access/usage information, potential exchange information, or the like. In one embodiment, the options in 603 may be updated or varied based on the assets, user profile, user preferences, service provider parameters, or the like. For example, the potential exchange information may be preliminary, which may be updated once and if the user “John” provides additional information about the assets.

FIG. 6B includes an illustration of a UI 620 that may be presented at a user device 101a. In one example, the UI 620 may include UI elements associated with an asset exchange application or service that may be available via an AE platform 108. In one embodiment, the UI 620 may include various options for a user to choose from. For instance, the UI 620 may present a list of assets in 621 where there user may select from one or more assets presented therein, which an AE platform 108 can further evaluate for providing one or more recommendations for exchange with other assets that may be available from one or more sources. In one embodiment, the assets in 601 may be categorized and presented in lists 623 “Owned Assets,” and 625 “rental Assets,” wherefrom the user may select one or more assets for further evaluations and exchange recommendations. Additionally, options list 627 may include options “Other Asset Sources” so that a user may select as to which asset sources/providers the users wishes to include in the evaluations and recommendations provided by an AE platform 108. In one example, the user “John” has selected (in 625) to evaluate his rental assets 3 and 4 with the inclusion of any asset source/provider (in 627) that may be able to provide other assets for exchange with his assets 3 and 4.

In FIG. 6C, the UI 620 presents additional information and UI elements based on the user selections in 625 and 627 of FIG. 6B. In one scenario, the UI 620 presents the list of assets 625 and results of the requested exchange evaluation and recommendation. For example, 641 presents information about a possible exchange of the Asset-3, wherein the AE platform 108 may have determined from the metadata of the Asset-3, a content/asset/service provider, or the like sources. In this example, information 641 indicates that the Asset-3, “a rental application from a school,” has parameters that include restricted use or time, no transfer, and no exchange. In this example, the user may select from interactions options 643a to “Accept” or 643b to provide or request for “DRM?” information, which may prompt the AE platform 108 to re-evaluate the Asset-3. For instance, the user may provide DRM information (e.g., additional privileges) that may allow for evaluation for an exchange of the Asset-3. Similarly, information 645 provides exchange evaluation and recommendation for the Asset-4, which indicates that it may be exchanged, with the original provider of the Asset-4 (e.g., a VOD service provider), with an offer of 50% discount on a new asset rental, and further indicating that “Offer valid for the next 15 minutes.” In this example, the user may select from interaction options 643c to “Accept” or 643d to “Retry” the evaluation and recommendation for the Asset-4. In one embodiment, the user may select from other options such as presented in 647 to “Evaluate New Assets” for exchange.

FIG. 6D presents additional elements, information, and options in the UI 620, which may be utilized by a user to interact with an AE platform 108. In one embodiment, an AE platform 108 may identify and present a list of assets 661 associated with a user and enquire whether the user may wish to exchange some of his assets with other assets. In one embodiment, the AE platform 108 may determine the list 661 based on one or more parameters of the identified assets that most likely would be eligible for exchange. For example, the list 661 includes the assets 1, 6, 7, 8, and 9 (in 601) that are identified as owned by the user “John.” In one embodiment, the AE platform 108 may present one or more recommendations in 663, which may include parameters or information about other assets that may be available for exchange. For instance, as a starting point, the AE platform 108 may indicate in 663 that information about another Asset-X (e.g., a video game) that is available for exchange for the user's Asset-1 and Asset-6, validity period of the offer, or the like. In this scenario, the offer 663 may be indicative that the Asset-X may be valued higher than the value of each of the Asset-1 or the Asset-6. In one embodiment, the user may select from interaction options 643 to “Accept,” “Retry” (e.g., with a different asset provider/source, select other assets from the list 661), or to “Refuse” the recommendation and offer in 663. Alternatively, the user may select to return or go to another UI element for interaction with an asset or an AE platform 108.

To the extent the aforementioned embodiments collect, store or employ personal information provided by individuals, it should be understood that such information shall be used in accordance with all applicable laws concerning protection of personal information. Additionally, the collection, storage and use of such information may be subject to consent of the individual to such activity, for example, through well known “opt-in” or “opt-out” processes as may be appropriate for the situation and type of information. Storage and use of personal information may be in an appropriately secure manner reflective of the type of information, for example, through various encryption and anonymization techniques for particularly sensitive information.

The exemplary techniques and systems presented herein enable an AE platform for identifying assets associated with a user and providing recommendations to exchange the assets. As an advantage, an AE platform 108 may be utilized to identify digital assets associated with a user and process metadata associated with the digital assets using an exchange rule to determine other digital assets or a parameter for initiating an exchange of the digital assets for the other digital assets. Further, the AE platform can present the other digital assets or the parameter to the user as an exchange recommendation.

The processes described herein for facilitating an AE platform may be implemented via software, hardware (e.g., general processor, Digital Signal Processing (DSP) chip, an Application Specific Integrated Circuit (ASIC), Field Programmable Gate Arrays (FPGAs), etc.), firmware or a combination thereof. Such exemplary hardware for performing the described functions is detailed below.

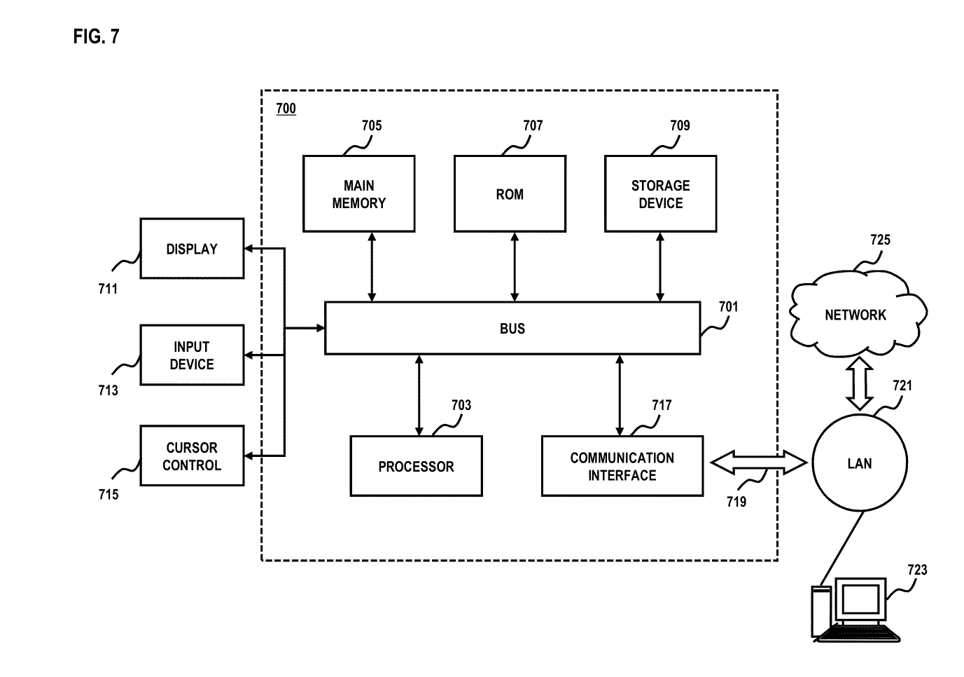

FIG. 7 illustrates computing hardware (e.g., computer system) upon which an embodiment according to the invention can be implemented. The computer system 700 includes a bus 701 or other communication mechanism for communicating information and a processor 703 coupled to the bus 701 for processing information. The computer system 700 also includes main memory 705, such as random access memory (RAM) or other dynamic storage device, coupled to the bus 701 for storing information and instructions to be executed by the processor 703. Main memory 705 also can be used for storing temporary variables or other intermediate information during execution of instructions by the processor 703. The computer system 700 may further include a read only memory (ROM) 707 or other static storage device coupled to the bus 701 for storing static information and instructions for the processor 703. A storage device 709, such as a magnetic disk or optical disk, is coupled to the bus 701 for persistently storing information and instructions.

The computer system 700 may be coupled via the bus 701 to a display 711, such as a cathode ray tube (CRT), liquid crystal display, active matrix display, or plasma display, for displaying information to a computer user. An input device 713, such as a keyboard including alphanumeric and other keys, is coupled to the bus 701 for communicating information and command selections to the processor 703. Another type of user input device is a cursor control 715, such as a mouse, a trackball, or cursor direction keys, for communicating direction information and command selections to the processor 703 and for controlling cursor movement on the display 711.

According to an embodiment of the invention, the processes described herein are performed by the computer system 700, in response to the processor 703 executing an arrangement of instructions contained in main memory 705. Such instructions can be read into main memory 705 from another computer-readable medium, such as the storage device 709. Execution of the arrangement of instructions contained in main memory 705 causes the processor 703 to perform the process steps described herein. One or more processors in a multiprocessing arrangement may also be employed to execute the instructions contained in main memory 705. In alternative embodiments, hard-wired circuitry may be used in place of or in combination with software instructions to implement the embodiment of the invention. Thus, embodiments of the invention are not limited to any specific combination of hardware circuitry and software.

The computer system 700 also includes a communication interface 717 coupled to bus 701. The communication interface 717 provides a two-way data communication coupling to a network link 719 connected to a local network 721. For example, the communication interface 717 may be a digital subscriber line (DSL) card or modem, an integrated services digital network (ISDN) card, a cable modem, a telephone modem, or any other communication interface to provide a data communication connection to a corresponding type of communication line. As another example, communication interface 717 may be a local area network (LAN) card (e.g. for Ethernet™ or an Asynchronous Transfer Mode (ATM) network) to provide a data communication connection to a compatible LAN. Wireless links can also be implemented. In any such implementation, communication interface 717 sends and receives electrical, electromagnetic, or optical signals that carry digital data streams representing various types of information. Further, the communication interface 717 can include peripheral interface devices, such as a Universal Serial Bus (USB) interface, a PCMCIA (Personal Computer Memory Card International Association) interface, etc. Although a single communication interface 717 is depicted in FIG. 7, multiple communication interfaces can also be employed.

The network link 719 typically provides data communication through one or more networks to other data devices. For example, the network link 719 may provide a connection through local network 721 to a host computer 723, which has connectivity to a network 725 (e.g. a wide area network (WAN) or the global packet data communication network now commonly referred to as the “Internet”) or to data equipment operated by a service provider. The local network 721 and the network 725 both use electrical, electromagnetic, or optical signals to convey information and instructions. The signals through the various networks and the signals on the network link 719 and through the communication interface 717, which communicate digital data with the computer system 700, are exemplary forms of carrier waves bearing the information and instructions.

The computer system 700 can send messages and receive data, including program code, through the network(s), the network link 719, and the communication interface 717. In the Internet example, a server (not shown) might transmit requested code belonging to an application program for implementing an embodiment of the invention through the network 725, the local network 721 and the communication interface 717. The processor 703 may execute the transmitted code while being received and/or store the code in the storage device 709, or other non-volatile storage for later execution. In this manner, the computer system 700 may obtain application code in the form of a carrier wave.

The term “computer-readable medium” as used herein refers to any medium that participates in providing instructions to the processor 703 for execution. Such a medium may take many forms, including but not limited to non-volatile media, volatile media, and transmission media. Non-volatile media include, for example, optical or magnetic disks, such as the storage device 709. Volatile media include dynamic memory, such as main memory 705. Transmission media include coaxial cables, copper wire and fiber optics, including the wires that comprise the bus 701. Transmission media can also take the form of acoustic, optical, or electromagnetic waves, such as those generated during radio frequency (RF) and infrared (IR) data communications. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, and EPROM, a FLASH-EPROM, any other memory chip or cartridge, a carrier wave, or any other medium from which a computer can read.

Various forms of computer-readable media may be involved in providing instructions to a processor for execution. For example, the instructions for carrying out at least part of the embodiments of the invention may initially be borne on a magnetic disk of a remote computer. In such a scenario, the remote computer loads the instructions into main memory and sends the instructions over a telephone line using a modem. A modem of a local computer system receives the data on the telephone line and uses an infrared transmitter to convert the data to an infrared signal and transmit the infrared signal to a portable computing device, such as a personal digital assistant (PDA) or a laptop. An infrared detector on the portable computing device receives the information and instructions borne by the infrared signal and places the data on a bus. The bus conveys the data to main memory, from which a processor retrieves and executes the instructions. The instructions received by main memory can optionally be stored on storage device either before or after execution by processor.

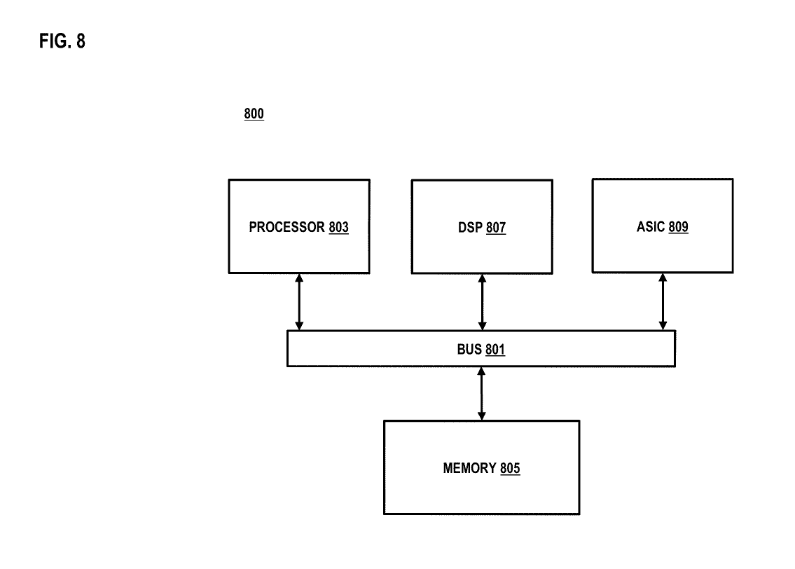

FIG. 8 illustrates a chip set 800 upon which an embodiment of the invention may be implemented. Chip set 800 is programmed to provide for identifying assets associated with a user and providing recommendations to exchange the assets at a user device includes, for instance, the processor and memory components described with respect to FIG. 7 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set can be implemented in a single chip. Chip set 800, or a portion thereof, constitutes a means for performing one or more steps of FIGS. 4 and 5.

In one embodiment, the chip set 800 includes a communication mechanism such as a bus 801 for passing information among the components of the chip set 800. A processor 803 has connectivity to the bus 801 to execute instructions and process information stored in, for example, a memory 805. The processor 803 may include one or more processing cores with each core configured to perform independently. A multi-core processor enables multiprocessing within a single physical package. Examples of a multi-core processor include two, four, eight, or greater numbers of processing cores. Alternatively or in addition, the processor 803 may include one or more microprocessors configured in tandem via the bus 801 to enable independent execution of instructions, pipelining, and multithreading. The processor 803 may also be accompanied with one or more specialized components to perform certain processing functions and tasks such as one or more digital signal processors (DSP) 807, or one or more application-specific integrated circuits (ASIC) 809. A DSP 807 typically is configured to process real-world signals (e.g., sound) in real time independently of the processor 803. Similarly, an ASIC 809 can be configured to performed specialized functions not easily performed by a general purposed processor. Other specialized components to aid in performing the inventive functions described herein include one or more field programmable gate arrays (FPGA) (not shown), one or more controllers (not shown), or one or more other special-purpose computer chips.

The processor 803 and accompanying components have connectivity to the memory 805 via the bus 801. The memory 805 includes both dynamic memory (e.g., RAM, magnetic disk, writable optical disk, etc.) and static memory (e.g., ROM, CD-ROM, etc.) for storing executable instructions that when executed perform the inventive steps described herein to controlling a set-top box based on device events. The memory 805 also stores the data associated with or generated by the execution of the inventive steps.

While certain exemplary embodiments and implementations have been described herein, other embodiments and modifications will be apparent from this description. Accordingly, the invention is not limited to such embodiments, but rather to the broader scope of the presented claims and various obvious modifications and equivalent arrangements.

What is claimed is:

1. A method comprising:
identifying one or more digital assets associated with a user;
processing metadata associated with the one or more digital assets using an exchange rule to determine one or more other digital assets, a parameter for initiating an exchange of the one or more digital assets for the one or more other digital assets, or a combination thereof; and
presenting the one or more other digital assets, the parameter, or a combination thereof to the user as an exchange recommendation.

2. A method of claim 1, further comprising:
extracting user consumption information for the one or more digital assets from the metadata, wherein the one or more other digital assets, the parameter, or a combination thereof are further determined based on the consumption information.

3. A method of claim 1, further comprising:
classifying the one or more digital assets, the one or more other digital assets, or a combination thereof into at least one category of: an on-demand asset, a purchased asset, a rental asset, a borrowed asset, or a combination thereof,
wherein the one or more other digital assets, the parameter, or a combination thereof are further determined based on the at least one category.

4. A method of claim 1, further comprising:
determining profile information, historical asset use information, or a combination thereof associated with the user, another user associated with the one or more other digital assets, or a combination thereof,
wherein the one or more other digital assets, the parameter, or a combination thereof are further determined based on the profile information, the historical asset use information, or a combination thereof.

5. A method of claim 1, further comprising:
determining valuation information for the one or more digital assets, the one or more other digital assets, or a combination thereof based on the metadata, the exchange rule, or a combination thereof,
wherein the parameter for initiating the exchange is further determined based on the valuation information.

6. A method of claim 1, wherein the metadata include asset rating information, asset age information, asset popularity information, asset scheduling information, asset availability information, or a combination thereof.

7. A method of claim 1, wherein the exchange rule specifies a one-to-one asset exchange, a many-to-one asset exchange, a many-to-many asset exchange, or a combination thereof.

8. An apparatus comprising:
a processor; and
a memory including computer program code for one or more programs,
the memory and the computer program code configured to, with the processor, cause the apparatus to perform at least the following:
identify one or more digital assets associated with a user;
process metadata associated with the one or more digital assets using an exchange rule to determine one or more other digital assets, a parameter for initiating an exchange of the one or more digital assets for the one or more other digital assets, or a combination thereof; and
present the one or more other digital assets, the parameter, or a combination thereof to the user as an exchange recommendation.

9. An apparatus of claim 8, wherein the apparatus is further caused to:
extract user consumption information for the one or more digital assets from the metadata, wherein the one or more other digital assets, the parameter, or a combination thereof are further determined based on the consumption information.

10. An apparatus of claim 8, wherein the apparatus is further caused to:
classify the one or more digital assets, the one or more other digital assets, or a combination thereof into at least one category of: an on-demand asset, a purchased asset, a rental asset, a borrowed asset, or a combination thereof,
wherein the one or more other digital assets, the parameter, or a combination thereof are further determined based on the at least one category.

11. An apparatus of claim 8, wherein the apparatus is further caused to:
determine profile information, historical asset use information, or a combination thereof associated with the user, another user associated with the one or more other digital assets, or a combination thereof,
wherein the one or more other digital assets, the parameter, or a combination thereof are further determined based on the profile information, the historical asset use information, or a combination thereof.

12. An apparatus of claim 8, wherein the apparatus is further caused to:
determine valuation information for the one or more digital assets, the one or more other digital assets, or a combination thereof based on the metadata, the exchange rule, or a combination thereof,
wherein the parameter for initiating the exchange is further determined based on the valuation information.

13. An apparatus of claim 8, wherein the metadata include asset rating information, asset age information, asset popularity information, asset scheduling information, asset availability information, or a combination thereof.

14. An apparatus of claim 8, wherein the exchange rule specifies a one-to-one asset exchange, a many-to-one asset exchange, a many-to-many asset exchange, or a combination thereof.

15. A system comprising:
An asset exchange platform configured to identify one or more digital assets associated with a user; process metadata associated with the one or more digital assets using an exchange rule to determine one or more other digital assets, a parameter for initiating an exchange of the one or more digital assets for the one or more other digital assets, or a combination thereof; and present the one or more other digital assets, the parameter, or a combination thereof to the user as an exchange recommendation.

16. A system of claim 15, wherein the asset exchange platform is further configured to:
extract user consumption information for the one or more digital assets from the metadata, wherein the one or more other digital assets, the parameter, or a combination thereof are further determined based on the consumption information.

17. A system of claim 15, wherein the asset exchange platform is further configured to:
classify the one or more digital assets, the one or more other digital assets, or a combination thereof into at least one category of: an on-demand asset, a purchased asset, a rental asset, a borrowed asset, or a combination thereof,
wherein the one or more other digital assets, the parameter, or a combination thereof are further determined based on the at least one category.

18. A system of claim 15, wherein the asset exchange platform is further configured to:
determine profile information, historical asset use information, or a combination thereof associated with the user, another user associated with the one or more other digital assets, or a combination thereof,
wherein the one or more other digital assets, the parameter, or a combination thereof are further determined based on the profile information, the historical asset use information, or a combination thereof.

19. A system of claim 15, wherein the asset exchange platform is further configured to:
determine valuation information for the one or more digital assets, the one or more other digital assets, or a combination thereof based on the metadata, the exchange rule, or a combination thereof,
wherein the parameter for initiating the exchange is further determined based on the valuation information.

20. A system of claim 15, wherein the metadata include asset rating information, asset age information, asset popularity information, asset scheduling information, asset availability information, or a combination thereof
